(19) United States
(12) Patent Application Publication
(10) Pub. No.: US 2025/0039859 A1
(43) Pub. Date: Jan. 30, 2025

(54) METHODS AND APPARATUS TO DETERMINE COMMUNICATION SCHEDULES FOR WIRELESS BATTERY SYSTEMS

(71) Applicant: Texas Instruments Incorporated, Dallas, TX (US)

(72) Inventors: Ariton Xhafa, Plano, TX (US); Yaron Alpert, Hod-Hasharon (IL)

(21) Appl. No.: 18/227,821

(22) Filed: Jul. 28, 2023

(51) Int. Cl. H04W 72/12; H04W 72/50; H04W 72/566

(52) U.S. Cl. CPC H04W 72/12; H04W 72/535; H04W 72/566; H04L 67/12

(57) ABSTRACT

An example apparatus includes: interface circuitry; and programmable circuitry configured to: transmit a first schedule to a set of battery modules, the first schedule to assign transmission slots to one or more of the set of battery modules for a first communication period; create a second schedule different from the first schedule; and transmit the second schedule to the set of battery modules, the second schedule to assign transmission slots to one or more of the set of battery modules for a second communication period.

### TECHNICAL FIELD

This description relates generally to batteries and, more particularly, to methods and apparatus to determine communication schedules in wireless battery systems.

### BACKGROUND

Hybrid electric vehicles (HEVs) and electric vehicles (EVs) are powered by battery systems that include batteries such as lithium-ion batteries. Battery systems may also include a battery management system to monitor the health of the batteries and report the health to a main electronic control unit (ECU) of the HEVs or EVs. The health of the batteries may be impacted by a wide range of conditions.

### SUMMARY

For methods and apparatus to determine communication schedules for wireless battery systems, an example apparatus includes interface circuitry; and programmable circuitry configured to: transmit a first schedule to a set of battery modules, the first schedule to assign transmission slots to one or more of the set of battery modules for a first communication period; create a second schedule different from the first schedule; and transmit the second schedule to the set of battery modules, the second schedule to assign transmission slots to one or more of the set of battery modules for a second communication period.

### BRIEF DESCRIPTION OF THE DRAWINGS

FIG. 1 is an illustrative example of a wireless battery management system (WBMS).

FIG. 2 is a block diagram of an example implementation of the WBMS of FIG. 1.

FIG. 3 is an illustrative example of a superframe interval usable by the WBMS of FIG. 1.

FIG. 4 is a flowchart representative of example machine readable instructions and/or example operations that may be executed, instantiated, and/or performed by the battery controller of FIG. 2 to determine superframe schedules.

FIG. 5 is a flowchart representative of example machine readable instructions and/or example operations that may be executed, instantiated, and/or performed by a battery module of FIG. 2 to transmit data.

FIG. 6 is a diagram of an example of a sequential schedule used by the WBMS of FIG. 1.

FIG. 7 is a diagram of an example of a non-sequential schedule used by the WBMS of FIG. 1.

FIG. 8 is a diagram of an example of multi-frame scheduling used by the WBMS of FIG. 1.

FIG. 9 is a block diagram of an example processing platform including programmable circuitry structured to execute, instantiate, and/or perform the example machine readable instructions and/or perform the example operations of FIGS. 4 and 5 to implement the WBMS 100 of FIG. 2.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Many HEVs and EVs include a system of batteries. Using multiple distributed batteries enables an increased amp-hour capacity than would otherwise be attainable with a single battery. The increased amp-hour capacity improves the functionality of the system (e.g., increased range, torque, or speed of the vehicle, etc.) compared to single battery alternatives. In some implementations of multiple distributed batteries, one or more individual batteries connect to a controller that coordinates operations at a system-level. In some examples, the individual battery cells and/or the circuits coupled to the battery cells may be called battery modules, secondary batteries, secondary nodes, secondary network nodes, secondary circuits, monitor circuits, etc. Similarly, the controller may be called a battery controller, a primary node, a primary network node, a primary controller, etc.

Some HVs and EVs enable communication between the battery modules and controller through a series of wired connections. HVs and EVs may additionally or alternatively use wireless connections to enable communication between the battery modules and the controller. In some examples, implementations utilizing wireless communication may be referred to as wireless battery systems (WBMSs). In some examples, WBMSs are used instead of wired alternatives because WBMSs reduce weight, complexity, and cost as compared to utilizing wired connections through a vehicle.

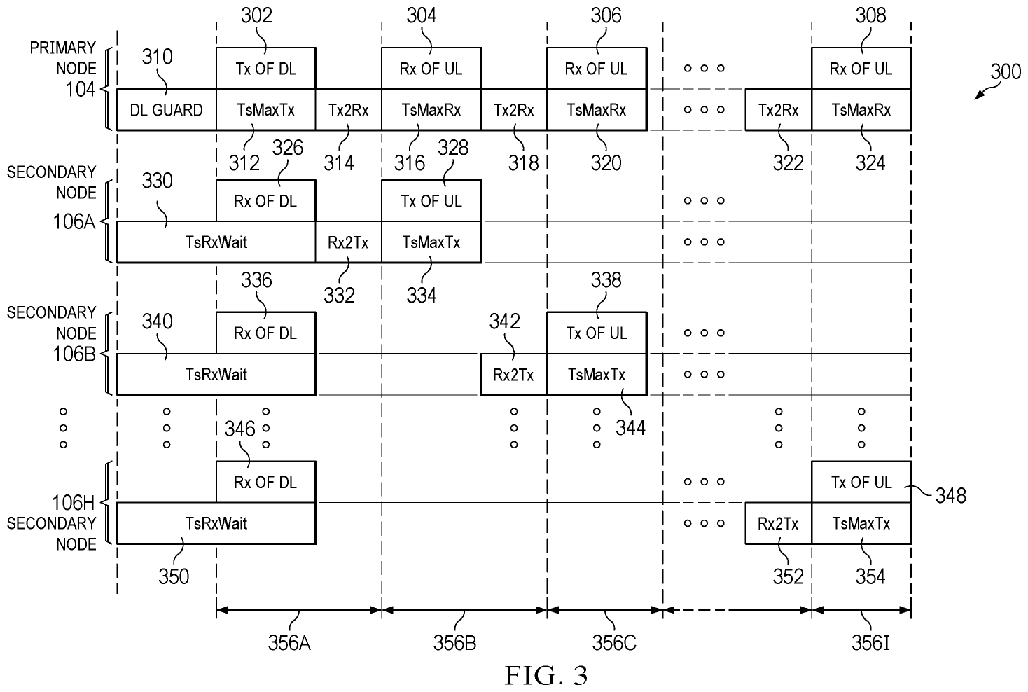

WBMSs may communicate over different protocols based on the use case. For example, in some automotive applications, industry members may use a WBMS superframe to establish communication between multiple battery modules and a controller. As used herein, the term “superframe” refers to a scheduled data exchange window that aggregate several bi-directional transmission slots. As used herein, a superframe may refer to a Transmission System 1 (T1) framing standard or any other bi-directional scheduled transmission protocol. Superframes are discussed further in connection with FIG. 3.

A superframe is an example implementation of a half-duplex bi-directional communication protocol. Half-duplex means only one of the battery modules or controller can be transmitting at a given time, while all other devices in the WBMS are receiving. Accordingly, WBMSs using superframes coordinate the usage of superframes between devices. The coordination may include communication parameters that include but are not limited to starting times, duration, slot allocation, frequency, etc.

Some WBMSs coordinate communication with superframes using a repeating, uniform structure. For example, the WBMS may divide some or all of the period within a communication period (referred to herein as a superframe interval) into uniform (equal) portions based on the number of battery modules. In such implementations, each battery module transmits once per superframe interval, and each battery module transmits for the same amount of time.

WBMSs may use the foregoing superframe coordination technique to support homogeneous battery modules (e.g., secondary nodes within little to no differences in design, performance, etc.). However, as the design of HEVs and EVs has evolved and complexity has increased, industry members have begun diversifying secondary nodes to form heterogeneous WBMSs. That is, new HEV or EV designs may include a variety of types of battery modules. The differing types of batteries may result in secondary nodes that request transmission to the controller to send different types and/or different sizes of messages. Accordingly, battery controllers that coordinate superframe communication in the foregoing repeating structure would be unable to implement a single controller that supports heterogeneous battery modules.

Example methods, systems, and apparatus described herein implement WBMSs that supports superframe communication with homogeneous or heterogeneous battery modules. As described below, an example battery controller (e.g., a primary node in the WBMS) may receive or obtain transmission requests from one or more battery modules. The example battery controller may be configured to then determine a schedule for a superframe interval either explicitly or implicitly. As used herein, schedule may refer to data that describes which battery modules are assigned to the transmission slots within a superframe interval. In some examples, the schedule is referred to as an allocation map. The battery modules assigned to a transmission slot may be a subset of battery modules connected to the battery controller, thereby skipping transmission for other battery modules. The transmitting battery modules may have unequal periods of transmission within the superframe interval. The battery controller may be configured to schedule extended periods within a given superframe sequentially or non-sequentially.

The functionality and communication demands of WBMSs are generally increasing over time. For example, newer WBMSs may integrate additional sensors such as pressure sensors, temperature sensors, and/or voltage sensors. Additional sensors can generate more data that the battery modules transmit to the battery controller. Over time, the commands sent by the battery controller may request more data (e.g., chunks of 128 bytes of data) to be read and sent back to the battery controller by the battery modules.

The schedule for the WBMS may be designed to meet fault diagnostics time intervals without supporting additional transmission in or beyond a single time slot. The battery controller may allocate resources in a static and/or rigid manner on a per define configuration or during the join flow such that a single slot is allocated to each battery module. The slot allocation or resource allocation schedule in the superframe may be fixed in that once a time slot is allocated to a battery module by the battery controller, the time slot does not change. In this example, the resource allocation does not support dynamic/valiant allocation of larger data transfers, which become more desirable as sensors and peripherals are added to WBMSs. Without support for larger data transfers, the data may become fragmented.

There may be a need for dynamic resource allocation to overcome a rigid and sometimes limiting resource allocation of some WBMSs. Dynamic resource allocation can allow the battery controller to dynamically and/or temporarily allocate more than one time slot for one or more battery modules. Dynamic resource allocation can also allow the battery controller to temporarily skip, temporarily suspend, and/or decrease the time slot allocation of a battery module. Moreover, dynamic resource allocation can allow a battery module to request an allocation of an increased number of time slots. In some examples, a WBMS may support non-equal resource allocation among the battery modules based on a specific service set of one or more battery modules. Additionally or alternatively, the WBMS can increase the system responsiveness by avoiding the fragmentation of slot allocation.

As described herein, using dynamic resource allocation, the battery controller may be configured to receive allocation request(s) from the battery modules, generate a superframe schedule based on the request(s), and communicate the schedule to the battery modules. The battery controller may be configured to skip, expand, delay, and/or shift time slot allocations for each of the battery modules. The battery controller can perform these actions using a slot allocation frame. Each battery module may be configured to request a change to a schedule to modify, renew, and/or suspend resources (e.g., time slot(s)). Although these techniques may incur some overhead, they may also provide flexibility and accommodation for larger data transfers, while maintaining a desirable frame size. These techniques may also allow for asymmetric and/or irregular service sets for the battery modules that are tailored to the communication demands on the battery modules. Of course, these advantages are merely examples, and no advantage is required for any particular embodiment.

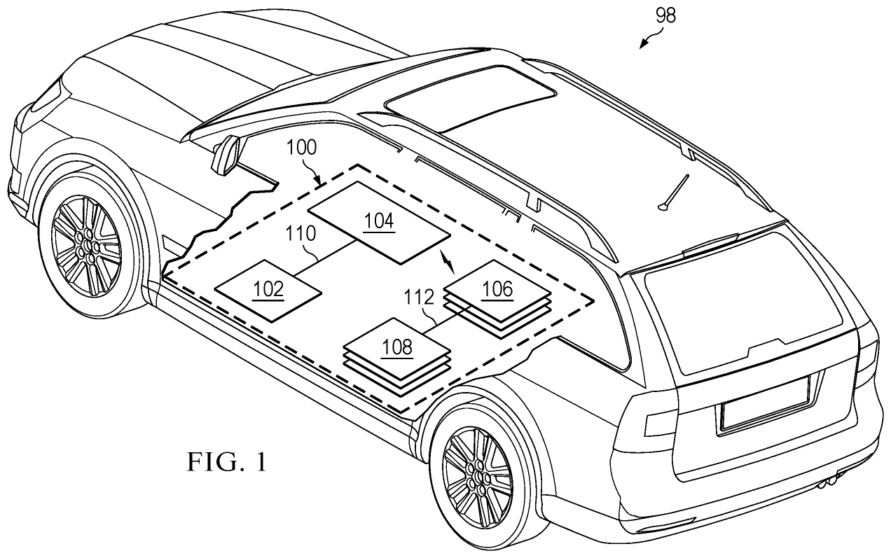

FIG. 1 is a block diagram of an illustrative example of a WBMS. FIG. 1 includes an example environment 98 and an example WBMS 100. The example WBMS 100 includes a primary network node 104, a battery controller 102, a plurality of secondary network nodes 106, a plurality of battery cells 108, and wired connections 110 and 112.

The environment 98 refers to any use case that may include a WBMS to supply power to one or more components. In FIG. 1, the environment 98 is an EV or an HEV. In other examples, the environment 98 is unrelated to the automotive industry.

The battery controller 102 determines different communication schedules within superframe intervals, thereby supporting heterogeneous battery modules in accordance with the teachings of this disclosure. The different communication schedules are used by the secondary network nodes 106 to send messages to the battery controller 102. In some examples, the battery controller 102 performs actions based on the messages. The battery controller 102 is discussed further in connection with examples described below.

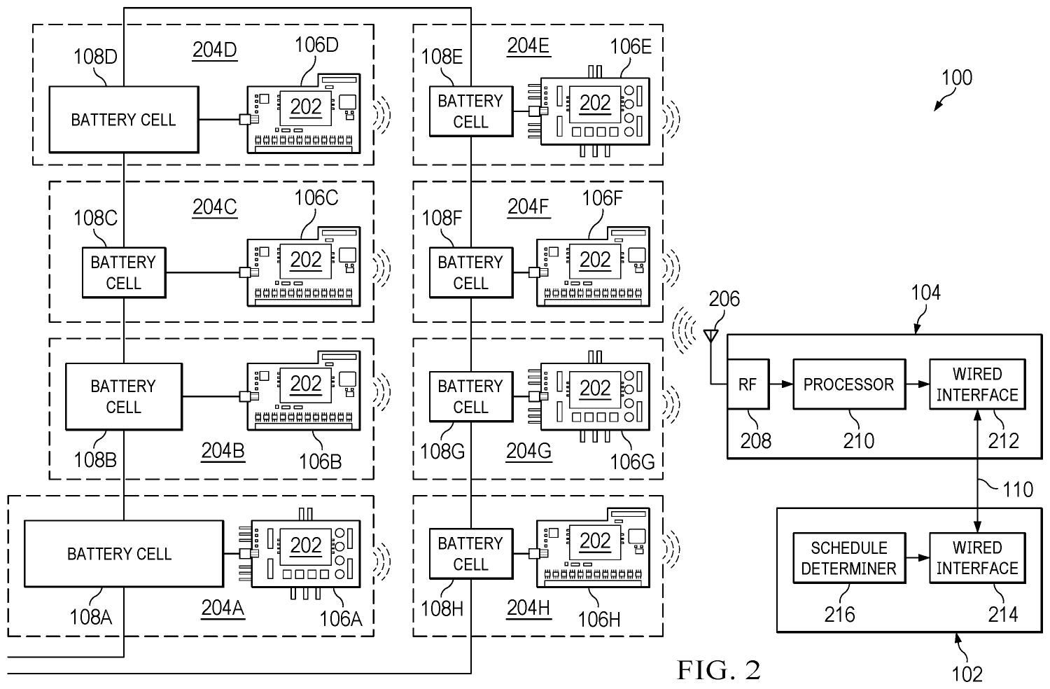

The primary network node 104 establishes communication between the battery controller 102 and the secondary network nodes 106. The primary network node 104 is coupled to the battery controller 102 using wired connection 110. Example communication protocols used over the first wired connection 110 between the primary network node 104 and the battery controller 102 is a universal asynchronous receiver/transmitter (UART), inter-integrated circuit (I2C), CAN bus, etc. In FIG. 1, the WBMS 100 includes a single primary network node 104. In other examples, a WBMS may include a plurality of primary network nodes. The primary network node 104 is discussed further in connection with FIG. 2.

The secondary network nodes 106 communicate with the battery controller 102 regarding the respective battery cells 108. The communications may describe any type of data, including but not limited to performance metrics, status updates, renegotiations, emergency codes, etc., of the battery cells 108. The secondary network nodes 106 also provide requests for transmissions within a superframe interval in accordance with the teachings of this disclosure. The secondary network nodes 106 are wirelessly coupled to the primary network node 104 and coupled to the battery cells 108 using the wired connection 112. The secondary network nodes 106 may implement any number of suitable hardware components, including but not limited to terminals, antennae, transmitters, receivers, etc., to support both wired and wireless communications. Although this disclosure describes communication techniques primarily in the context of wireless systems, these techniques may also be useful for wired systems (e.g., where the connection between primary network node 104 and secondary network nodes 106 is wired). The secondary network nodes 106 are discussed further in connection with FIG. 2.

FIG. 2 is a block diagram of an example implementation of the WBMS 100 of FIG. 1. The WBMS 100 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the WBMS 100 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example block diagram of FIG. 2 includes the battery controller 102, primary network node 104, secondary network nodes 106A-106H (which collectively form secondary network nodes 106), and battery cells 108A-108H (which collectively form battery cells 108). Each of the secondary network nodes 106 include example schedule requester circuitry 202. As used herein, a secondary network node 106A and its corresponding battery cell 108A are collectively referred to as a battery module 204A. Accordingly, the battery modules 204A-204H collectively form the battery modules 204. The primary network node 104 includes an example antenna 206, example radio frequency (RF) circuitry 208, an example processor 210 and example wired interface circuitry 212. The battery controller 102 includes example wired interface circuitry 214 and example schedule determiner circuitry 216. While FIG. 2 shows eight battery modules 204 and one battery controller 102, in other examples, the WBMS 100 includes any number of battery modules and battery controllers. For example, WBMS 100 may include two or more battery controllers, where a first set of the secondary network nodes are assigned to communicate with a first battery controller, and a second set of the secondary network nodes are assigned to communicate with a second battery controller. The first and second sets of secondary network nodes may or may not overlap.

The battery modules 204 wirelessly communicate with the primary network node 104 using consecutive superframe intervals. That is, a first superframe containing a first set of communications is followed by a second superframe containing a second set of communications, etc. Within a given battery module 204A, the schedule requester circuitry 202 determines whether a transmission regarding the corresponding battery cell 108A should be made in an upcoming superframe interval. The schedule requester circuitry 202 may determine whether to make a transmission based on factors that include but are not limited to status and performance of the corresponding battery cell 108A.

The schedule requester circuitry 202 optionally requests to be included on a schedule for an upcoming superframe interval based on the result of the determination and in accordance with the teachings of this disclosure. Accordingly, the battery modules 204 do not request to make a transmission in an upcoming superframe interval every time an opportunity to make a request is available. The schedule requester circuitry 202 may provide additional information to the battery controller 102 when requesting a transmission in an upcoming superframe interval. For example, the schedule requester circuitry 202 may request an extra uplink allocation in addition to the transmission slot that is normally allocated in a default schedule. Default schedules are discussed further in connection with FIG. 3. The schedule requester circuitry 202 may also request a specific number of requested time slots, request a specific duration of uplink time, and/or request a specific data size to uplink (e.g., a specific number of blocks, bytes, or bits), etc. Alternatively, the request sent by the schedule requester circuitry 202 may indicate only that a corresponding battery module 204A is requesting more time for transmission, without any specifics about the requested time duration, number of time slots, or uplink size.

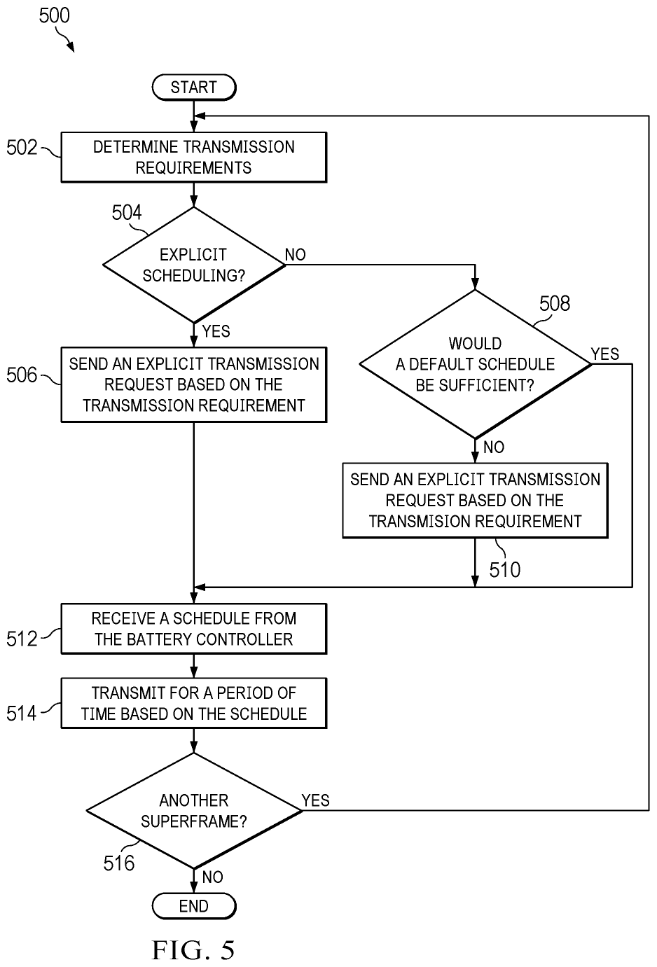

In the example of FIG. 2, each instance of the schedule requester circuitry 202 is implemented within the secondary network nodes 106. In other examples, one or more instances of the schedule requester circuitry 202 are implemented elsewhere within the respective battery modules 204. In some examples, the schedule requester circuitry 202 is instantiated by programmable circuitry executing schedule requester instructions and/or configured to perform operations such as those represented by the flowchart(s) of FIG. 5.

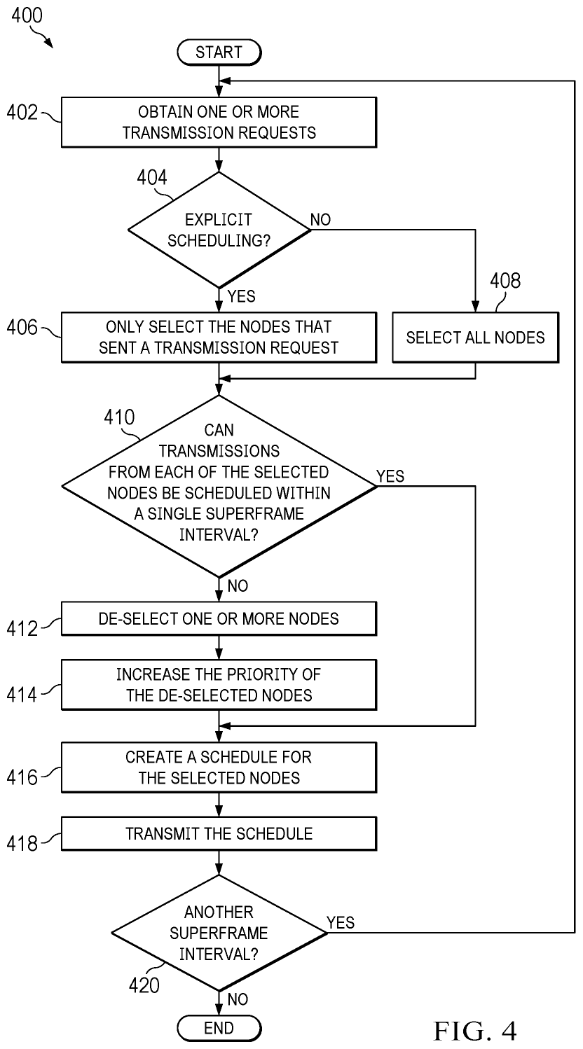

Within the primary network node 104, the RF circuitry 208 communicates wirelessly with the secondary network nodes 106 via the antenna 206. The RF circuitry 208 may use the license-free 2.4 gigahertz (GHz) industrial, scientific, and medical (ISM) band from 2.4 GHz to 2.483 GHz, which is compliant with the Bluetooth Special Interest Group (SIG). Additionally or alternatively, the RF circuitry 208 may use 2 megabits per second (Mbps) Bluetooth Low Energy (BLE) across the physical layer (PHY). The Open Systems Interconnection (OSI) model includes the PHY as a layer used for communicating raw bits over a physical medium. In examples described herein, the PHY is free space, which the wireless battery management system 100 uses to wirelessly communicate between the primary network node 104 and the secondary network nodes 106. In some examples, the RF circuitry 208 is instantiated by programmable circuitry executing RF instructions and/or configured to perform operations such as those represented by the flowchart(s) of FIG. 4.

Within the primary network node 104, the processor 210 both interprets the contents of data received by the primary network node 104 and determines the contents of data to be transmitted by the primary network node 104. In doing so, the processor 210 helps establish communication between the battery modules 204 and the battery controller 102. The processor 210 may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

Within the primary network node 104, the wired interface circuitry 212 sends and receives communications with the battery controller 102 via the wired connection 110. The wired interface circuitry 212 may implement any suitable hardware components, including but not limited to terminals, pins, interconnects, etc., to implement wired communications.

Similarly, within the battery controller 102, the wired interface circuitry 214 sends and receives communications with the primary network node 104 via the wired connection 110. The wired interface circuitry 214 may implement any suitable hardware components to implement wired communications.

The schedule determiner circuitry 216 determines different communication schedules for different superframe intervals, thereby supporting heterogeneous battery modules in accordance with the teachings of this disclosure. The schedule determiner circuitry 216 adjusts a schedule and/or creates new schedules for superframe intervals based on the transmission request transmitted by the multiple instances of the schedule requester circuitry 202. Examples of schedule adjustment and schedule creation are discussed further in connection with FIG. 3.

In the example of FIG. 2, the schedule determiner circuitry 216 is implemented within the battery controller 102. In other examples, the schedule determiner circuitry 216 is implemented within the primary network node 104 or elsewhere within the WBMS 100. In some examples, the schedule determiner circuitry 216 is instantiated by programmable circuitry executing schedule determiner instructions and/or configured to perform operations such as those represented by the flowchart(s) of FIG. 4.

The battery modules 204 are heterogeneous in the sense that the design, manufacture, capabilities, and/or performance of a first battery module may differ from that of a second battery module. For example, in FIG. 2, battery cells 108A, 108B, 108D store a larger amount of charge than battery cells 108C, 108E-108H. Furthermore, the amount of charge stored in battery cells 108A, 108B, 108D is nonuniform. In an additional example, FIG. 2 illustrates the secondary network nodes 106A, 106E, 106G implemented by a first type of programmable circuitry, and secondary network nodes 106B-106D, 106F, 106H implemented by a different type of programmable circuitry. While the example FIG. 2 illustrates variance in battery capacity and type of programmable circuitry, in practice, the battery modules 204 may include other types of differences.

In some examples, the heterogeneity of the WBMS 100 causes some battery modules to seek communication with the battery controller 102 more frequently than other battery modules. Some battery modules may additionally or alternatively transmit different types of information within a superframe interval than other battery modules. For example, the battery module 204A may seek to report a storage capacity measurement when the battery module 204B seeks to report an error code. The battery controller 102 enables such diverse forms of communication by obtaining requests for transmissions sent by the battery modules 204 and determining a schedule for each superframe interval. Advantageously, the battery controller 102 may use different schedules for different superframe intervals. Therefore, if a first superframe interval is not long enough to support all the transmissions concurrently requested by the battery modules 204, the battery controller 102 can create a first schedule where a first subset of battery modules 204 transmit information and a second schedule where a second subset of battery modules 204 transmit information. Accordingly, the WBMS 100 coordinates the battery modules 204 to communicate within superframe intervals of a fixed period of time, even when the information communicated varies by length and priority between modules.

FIG. 3 is an illustrative example of a superframe interval usable by the WBMS of FIG. 1. FIG. 3 illustrates the example schedule 300, which includes a downlink (DL) transmit transmission period 302, uplink (UL) receive transmission periods 304, 306, 308, a DL guard transmission period 310, a DL transmit time transmission period 312, transmit to receive transmission periods 314, 318, 322, UL receive time transmission periods 316, 320, 324, DL receive transmission periods 326, 336, 346, UL transmit transmission periods 328, 338, 348, receive wait times 330, 340, 350, receive to transmit transmission periods 332, 342, 352, UL transit time transmission periods 334, 344, 354, and transmission slots 356A-356I. As used herein, the term TsMaxRx denotes the maximum (Max) time (Ts) allocated for receiving a packet (Rx) within a transmission slot, and the term TsMaxTx denotes the maximum (Max) time (Ts) allocated for transmitting a packet (Tx) within a transmission slot.

The schedule 300 describes a superframe interval, which is a medium access control (MAC) for data exchange between the primary network node 104 and the secondary network nodes 106 during the transmission slots 356A-356I. Each transmission slot 356A-356I refers to the same amount of time in accordance with a T1 superframe standard. The transmission slots 356A-356I occur in a half-duplex mode, as both the primary network node 104 and the secondary network nodes 106 switch between transmit and receive modes according to the temporal moment specified in scan/pairing transmission slots of exchanged data for downlink (DL)/uplink (UL) durations. In some examples, the transmission slots 356A-356I may be referred to as transmission frames 356A-356I and/or resource assignments 356A-356I respectively. Additional example details of superframes in WBMSs can be found in commonly assigned U.S. patent application Ser. No. 17/828,895, entitled “Efficient Unicast Super Frame Communications,” filed on May 31, 2022, and U.S. patent application Ser. No. 17/977,906, entitled “Methods, Apparatus, and Articles of Manufacture to Improve One-Hop Extension in Wireless Battery Management Systems,” filed Oct. 31, 2022, each of which is incorporated by reference in its entirety.

In the example of FIG. 3, the superframe interval described by the schedule 300 starts with the DL guard transmission period 310. The DL guard transmission period 310 is used to ensure there is no interference between subsequent superframes. At the time of the DL guard transmission period 310, the secondary network node 106A enters the receive wait time 330, the secondary network node 106B enters the receive wait time 340, etc., and the secondary network node 106H enters the receive wait time 350. In other examples, the schedule 300 begins with data other than a DL transmitted to all secondary network nodes 106.

In transmission slot 356A of the schedule 300, after the DL guard transmission period 310, the primary network node 104 transmits the DL using the DL transmit transmission period 302 during the DL transmit time transmission period 312 to all the secondary network nodes 106. Each of the secondary network nodes 106B-106H receive the DL using the DL receive transmission period 326, 336, . . . , 346. After the DL transmit transmission period 302, the primary network node 104 enters the transmit to receive transmission period 314 in preparation to receive the ULs from each of the secondary network nodes 106. At the same time as the primary network node 104 enters the transmit to receive transmission period 314, the secondary network node 106A enters the receive to transmit transmission period 332 in preparation to transmit a UL to the primary network node 104.

In UL transmission slot 356B of the schedule 300, the secondary network node 106A transmits the UL using the UL transmit transmission period 328 and during the UL transmit time transmission period 334. The primary network node 104 receives the UL using the UL transmission period 304 and during the UL receive time transmission period 316. During transmission slot 356B, the primary network node 104 enters the transmit to receive transmission period 318 in preparation to receive a UL from the secondary network node 106B. At the same time, the secondary network node 106B enters the receive to transmit transmission period 342 in preparation to transmit a UL to the primary network node 104.

In transmission slot 356C of the schedule 300, the secondary network node 106B transmits the second UL using the UL transmit transmission period 338 and during the UL transmit time transmission period 344. The primary network node 104 receives the UL using the UL receive transmission period 306 and during the UL receive time transmission period 320. In transmission slot 356C, the primary network node 104 enters a transmit to receive transmission period in preparation to receive a UL from the secondary network node 106C (not shown). Similarly, during transmission slot 356C the secondary network node 106C enters a receive to transmit transmission period in preparation to transmit a UL to the primary network node 104 (not shown).

The foregoing pattern of UL transmissions repeats throughout transmission slots 356D-356H (not shown). In transmission slot 356I of the schedule 300, the secondary network node 106H transmits a UL using the UL transmit transmission period 348 and during the UL transmit time transmission period 354. The primary network node 104 receives the UL using the UL receive transmission period 308 and during the UL receive time transmission period 324.

The schedule 300 is an example implementation of a schedule determined by the battery controller 102 to organize communication between the primary network node 104 and the secondary network nodes 106 for wireless battery management purposes.

In examples described above and herein, the ordered listing causes the secondary network node 106A to transmit first (if assigned a transmission slot), the secondary network node 106B to transmit second (if assigned a transmission slot), etc. In other examples, a different ordered listing is used.

In FIG. 3, after the primary network node 104 transmits a DL during transmission slot 356A, each of the secondary network nodes 106A-106H communicate with the primary network node 104 during transmission slots 356B-356I, respectively. In some examples, the schedule of transmission slots 356A-356I shown in FIG. 3 may be referred to herein as a default schedule or standard schedule.

In some examples, a schedule includes an ordered listing that describes the order in which secondary network nodes 106 communicate in a superframe interval. The ordered listing may be described using any suitable data structure, including but not limited to indices. For example, in the default schedule described above, if battery module 204A has an index of 1, then battery module 204B has an index of 2, battery module 204C has an index of 3, etc. In such an ordered listing, battery modules with consecutive indices will transmit data in adjacent transmission slots (e.g., without any intermediates transmissions from other battery modules).

The default schedule of FIG. 3 forms communication constraints in that: (a) every battery module within the WBMS transmits within the superframe, and (b) each of the connected battery modules are assigned the same amount of time to transmit information. Many WBMS with homogeneous battery modules (e.g., some or all of the battery modules are duplicated instances of one another) can regularly operate within the foregoing communication constraints. Accordingly, existing battery controllers generally use a single schedule (e.g., the default schedule of FIG. 3 or a variant thereof) for every superframe interval.

As more diverse battery modules (e.g., the battery modules 204) are used across various environments, new WBMS implementations are unable to operate with the foregoing communication constraints because the variety of message lengths and priorities cannot always be mapped to a default schedule. In a diverse set of battery modules, a given battery module may inform the battery controller 102 that the battery module plans to request x transmission slots once every y superframes (where x and y are any positive integer). For example, battery module 204A may regularly request two transmission slots once every three superframe intervals, while battery module 204B regularly requests four transmission slots once every two superframe intervals. Additionally, one or more of the heterogeneous battery modules 204 may request transmission slots at irregular intervals (e.g., without a definable pattern as described above). In contrast, a battery controller connected to a set of homogeneous battery modules can presume each battery module regularly requests one transmission slot every one superframe interval.

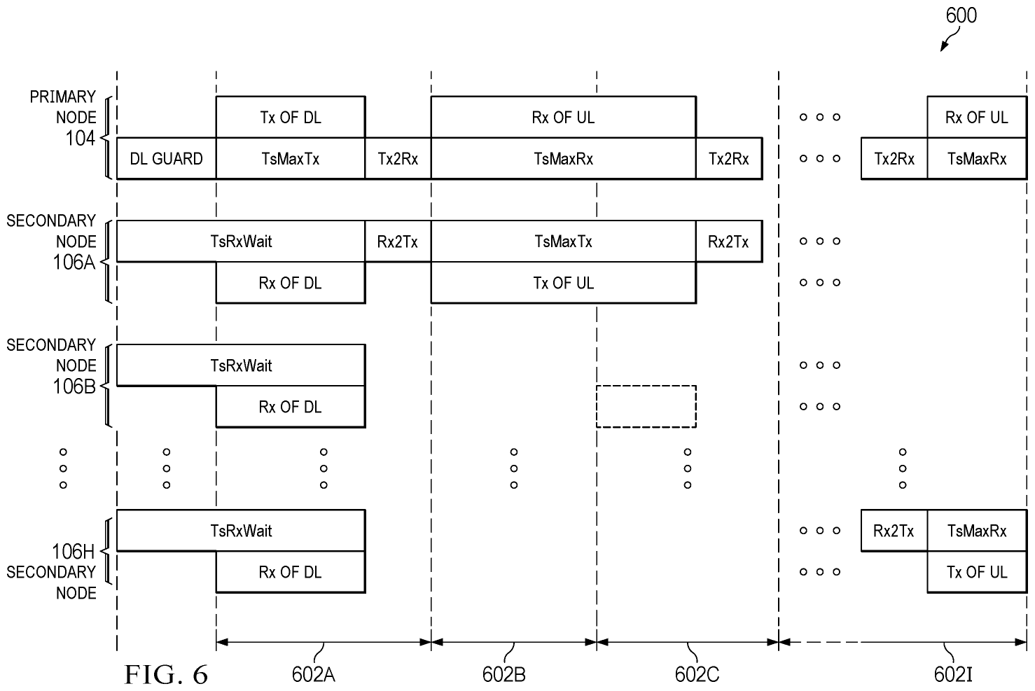

Advantageously, the schedule determiner circuitry 216 within the battery controller 102 can form alternate schedules that are used in addition to or replacement of the default schedule of FIG. 3. The schedule determiner circuitry 216 may use alternate schedules in one or more consecutive superframe intervals to support the variety of message lengths and priorities generated by the heterogenous battery modules 204. For example, suppose the schedule determiner circuitry 216 sends the default schedule of FIG. 3 for use by the battery modules 204 within an initial superframe interval. Suppose the schedule determiner circuitry 216 then uses one or more transmission requests to determine battery module 204A has a high priority message that that should be transmitted in its entirety within the next superframe interval. In such an example, the schedule determiner circuitry 216 may create a second schedule that increases the amount of time for the battery module 204A to transmit relative to the default schedule. Consequently, the battery controller 102 may enable a high-priority battery module to uplink data more quickly. To compensate for the increase in time for battery module 204A, the second schedule may also decrease the amount of time assigned to a different one of the battery modules 204. Examples of alternate schedules formed by the schedule determiner circuitry 216 are discussed further in connection with FIGS. 6-8.

The foregoing example describes the schedule determiner circuitry 216 creating an alternate schedule based on one or more transmission requests. Advantageously, the schedule determiner circuitry 216 can also create an alternate schedule without receiving a transmission request. In general, the schedule determiner circuitry 216 may create a schedule based on any type of schedule criteria. In the foregoing example, the schedule criteria is a transmission request. In other examples, the schedule criteria is a policy that describes when and/or how a schedule should change. The policy may be based on regularly scheduled requests from the battery modules (e.g., as described above, battery module 204A informs the battery controller 102 it plans to request two transmission slots once every three superframe intervals, while battery module 204B informs the battery controller 102 it plans to request four transmission slots once every two superframe intervals). The policy may additionally or alternatively be based on other sources (e.g., received from an Electronic Control Unit (ECU) within the vehicle, stored as pre-determined machine readable instructions within the battery controller 102, etc.)

While an example manner of implementing the WBMS 100 of FIG. 1 is illustrated in FIG. 2, one or more of the elements, processes, and/or devices illustrated in FIG. 2 may be combined, divided, re-arranged, omitted, eliminated, and/or implemented in any other way. Further, the battery controller 102, wired interface circuitry 214, schedule determiner circuitry 216, primary network node 104, RF circuitry 208, processor 210, wired interface circuitry 212, secondary network nodes 106, schedule requester circuitry 202, and battery cells 108 of FIG. 2, may be implemented by hardware alone or by hardware in combination with software and/or firmware. Thus, for example, any of the battery controller 102, wired interface circuitry 214, schedule determiner circuitry 216, primary network node 104, RF circuitry 208, processor 210, wired interface circuitry 212, secondary network nodes 106, schedule requester circuitry 202, and battery cells 108 of FIG. 2, and/or, more generally, the example WBMS 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example WBMS 100 of FIG. 2 may include one or more elements, processes, and/or devices in addition to, or instead of, those illustrated in FIG. 2, and/or may include more than one of any or all of the illustrated elements, processes and devices.

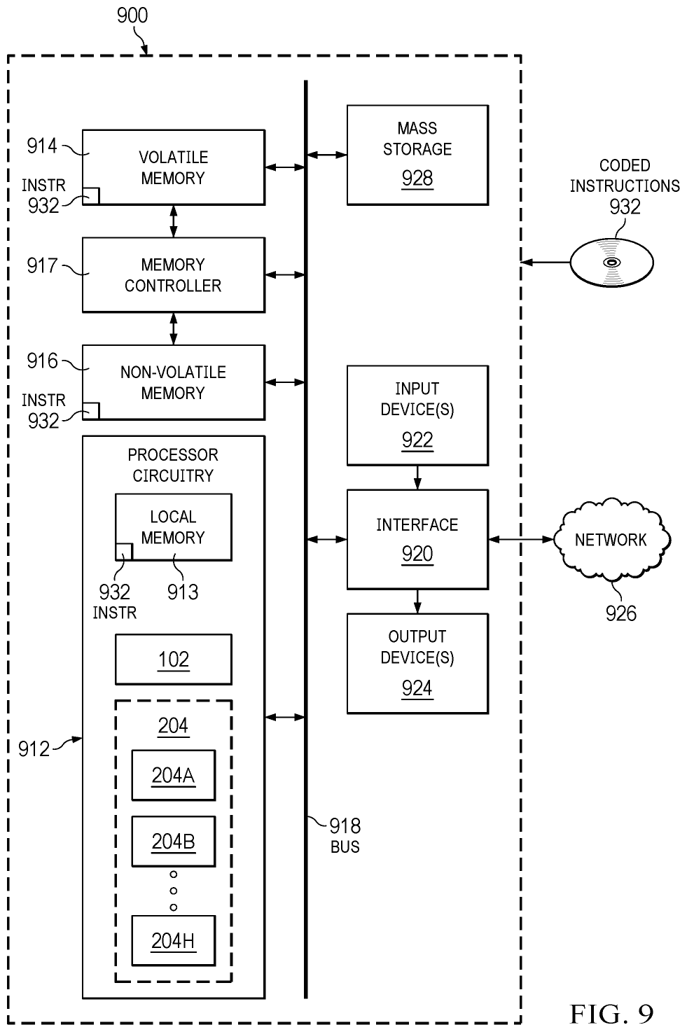

Flowchart(s) representative of example machine readable instructions, which may be executed by programmable circuitry to implement and/or instantiate the WBMS 100 of FIG. 1 and/or representative of example operations which may be performed by programmable circuitry to implement and/or instantiate the WBMS 100 of FIG. 2, are shown in FIGS. 4 and 5. The machine readable instructions may be one or more executable programs or portion(s) of one or more executable programs for execution by programmable circuitry such as the programmable circuitry 912 shown in the example programmable circuitry platform 900 described below in connection with FIG. 9 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program maybe embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and 5, many other methods of implementing the example WBMS 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to determine superframe schedules. The example machine-readable instructions and/or the example operations 400 of FIG. 4 begin when the schedule determiner circuitry 216 within the battery controller 102 obtains one or more transmission requests. (Block 402). The one or more transmission requests are submitted by one or more of the battery modules 204, transmitted wirelessly to the primary network node 104, and provided to the battery controller 102 via the wired connection 110. In some examples, the battery controller 102 obtains the transmission requests in a period between subsequent superframe intervals. Each transmission request can indicate a requested allocation that is absolute or relative to a previous request or allocation. Additionally, each request can indicate an allocation restriction, such as timing, power, delay, and/or another characteristic.

As used above and herein, a transmission request may refer to metadata that indicates a battery module has data to transmit in an upcoming superframe interval. A transmission request may describe such an indication using any number of suitable parameters. Examples of information provided within a transmission request includes but is not limited to an identification of the battery module sending the request, a description of the amount of data to be transmitted in a superframe interval, a description of the type of data to be transmitted, a timing requirement, a power requirement, a self-assigned priority level, etc. A priority level within a transmission request may be referred to as self-assigned because such metadata describes how a battery module 204A characterizes its own data within the context of other data sent by the same battery module 204A.

The schedule determiner circuitry 216 determines whether to use explicit scheduling. (Block 404). The schedule determiner circuitry 216 may determine a schedule either implicitly or explicitly. In some examples, the schedule determiner circuitry 216 is hardcoded to always use the same scheduling technique. In other examples, the schedule determiner circuitry 216 is configurable and can switch between explicit or implicit scheduling based on the desired use case.

Advantageously, the WBMS 100 ensures that the battery modules 204 are informed of which scheduling technique the schedule determiner circuitry 216 uses by the time block 404 is executed (e.g., during the period in which the battery modules 204 generate transmission requests). In some examples, the scheduling technique information is exchanged during an initialization period between a given battery module 204A and the battery controller 102. Accordingly, the battery module 204A can use the scheduling technique information when determining whether to generate a transmission request. The generation of a transmission request by a battery module 204A is discussed further in connection with FIG. 5.

If the schedule determiner circuitry 216 uses explicit scheduling (Block 404: Yes), the schedule determiner circuitry 216 only selects the secondary network nodes 106 that sent a transmission request. (Block 406). In explicit scheduling, a secondary network nodes 106A must indicate the battery module 204A has information to transmit in order to be assigned a transmission slot in an upcoming superframe interval. If a secondary network node 106A does not send a transmission request when explicit scheduling is used, the schedule determiner circuitry 216 presumes the secondary network node 106A does not have information to share In such an example the schedule determiner circuitry 216 may create a schedule that does not assign a transmission slot to the secondary network node 106A, thereby preventing the secondary network node 106A from transmitting within the upcoming superframe interval. Control proceeds to block 410 after block 408.

If the schedule determiner circuitry 216 uses implicit scheduling (Block 404: No), the schedule determiner circuitry 216 selects all of the secondary network nodes 106. (Block 408). In implicit scheduling, the schedule determiner circuitry 216 starts with the presumption that each of the battery modules 204 have an implicit transmission request to use the default schedule of FIG. 3. In such an example, a given battery module 204A need only send an explicit transmission request in block 402 if the battery module 204A determines the transmission requirement would not be satisfied by the default, implicit transmission request. That is, within the same superframe interval, a battery controller 102 using implicit scheduling may assign a first transmission slot to a battery module 204A that did send a transmission request and assign a second transmission slot to a battery module 204B that did not send a transmission request. The determination of a transmission requirement by a battery module 204A is discussed further in connection with FIG. 5.

The selections of block 406 or 408 both describe the set of secondary network nodes 106 that want to transmit information within an upcoming superframe interval. After making a selection, the schedule determiner circuitry 216 then determines whether transmissions from each of the selected nodes can be scheduled within a single superframe interval. (Block 410). The determination is made based on the fixed amount of time provided within a superframe interval and the total amount of data to be transmitted. For example, if as single superframe interval is 10 ms in total, and the transmission requests indicate the secondary network nodes 106 have collectively requested to transmit data over a span of 15 ms, then every node wishing to transmit data cannot do so within a single interval. In the case of implicit scheduling, the schedule determiner circuitry may presume a battery module 104A has an amount of data to transmit that can fit within one of the transmission slots 356B-356I, unless otherwise indicated by a transmission request.

If the schedule determiner circuitry 216 determines the transmissions from each of the selected nodes can be scheduled within a single superframe interval (Block 410: Yes), control proceeds to block 416. Alternatively, if the schedule determiner circuitry 216 determines the transmissions from each of the selected nodes cannot be scheduled within a single superframe interval (Block 410: No), the schedule determiner circuitry 216 de-selects one or more secondary network nodes 106. (Block 412).

By de-selecting a secondary network node 106A, the battery controller removes a given battery module 204A from the set of battery modules that will transmit within the next superframe interval. The schedule determiner circuitry 216 may de-select one or more secondary network nodes 106 at block 412 based on any number of factors. In some examples, the schedule determiner circuitry 216 de-selects a secondary network node 106B based on the order of secondary network nodes 106 in the default schedule. In other examples, the schedule determiner circuitry 216 assigns priority levels to one or more secondary network nodes 106 and de-selects a secondary network node 106 based on the prioritization. In contrast to the self-assigned priority levels that may be generated by a battery module 204A and included in a transmission request, priority levels that are assigned or adjusted by the battery controller 102 at block 412 characterize data from a particular battery module 204A within the context of the set of all connected battery modules 204. In some examples, de-selecting a node is referred to as skipping the node. Examples of skipping nodes are discussed further in connection with FIGS. 6-8.

The schedule determiner circuitry 216 increases the priority of the de-selected nodes. (Block 414). Because the de-selected nodes are prevented from transmitting in a first superframe interval, the schedule determiner circuitry 216 increases the priority so that the foregoing nodes have a higher chance of being assigned a transmission slot within the following superframe interval. That is, during a subsequent iteration of block 412, the schedule determiner circuitry 216 is more likely to keep the foregoing nodes selected due to the increased priority levels of block 414.

The schedule determiner circuitry 216 creates a schedule for the selected nodes. (Block 416). To create the schedule, the schedule determiner circuitry 216 assigns a transmission slot to every secondary network node 106 that is still selected at block 416. In some examples, the schedule created at block 416 is: (a) the default schedule of FIG. 3, or (b) an adjustment to the default schedule of FIG. 3. In other examples, the schedule created at block 416 is unrelated to the default schedule. Examples of schedules created by the schedule determiner circuitry 216 are discussed further in FIGS. 6-8.

The schedule determiner circuitry 216 transmits the schedule to one or more nodes. (Block 418). In some examples, the schedule determiner circuitry 216 multicasts the schedule to all secondary network nodes 106. In other examples, the schedule determiner circuitry 216 sends the schedule to the subset of secondary network nodes 106 that are assigned a transmission slot. To provide the schedule to the battery modules 204, the battery controller 102 first transmits the schedule to the primary network node 104, which then transmits the schedule wirelessly via the RF circuitry 208 and antenna 206.

The schedule determiner circuitry 216 determines whether another superframe interval is required. (Block 420). An additional superframe may be required whenever one or more of the battery modules 204 have data to provide to the battery controller 102. If another superframe interval is required (Block 420: Yes), control returns to block 402, where the battery controller 102 obtains additional transmission requests from one or more of the battery modules 204. If another superframe interval is not required (Block 420: No), the machine readable instructions and/or operations 400 end.

In the example flowchart of FIG. 6, the decision to form an alternate schedule is based on the one or more transmission requests received at block 402. In some examples, the decision to form an alternate schedule at block 402 is additionally or alternatively based on a policy implemented by the battery controller 102.

FIG. 5 is a flowchart representative of example machine readable instructions and/or example operations that may be executed, instantiated, and/or performed by a battery module of FIG. 2 to transmit data. While the flowchart of FIG. 5 is described herein with reference to battery module 204A, each of the battery modules 204 may implement the flowchart of FIG. 5 in parallel. The example machine-readable instructions and/or the example operations 500 of FIG. 5 begin when, within the battery module 204A, the schedule requester circuitry 202 determines transmission requirements. (Block 502). To determine transmission requirements, the schedule requester circuitry 202 determines what data, if any, is ready for transmission to the battery controller. The data may describe any information related to the battery cell 108A, including but not limited to status updates, performance metrics, error codes, etc. In some examples, a transmission requirement includes a self-assigned priority level. For example, the schedule requester circuitry 202 may determine that reporting an error code to the battery controller 102 is more important (and therefore should have a higher priority level) than providing a status update to the controller.

The schedule requester circuitry 202 determines whether the battery controller 102 is using explicit scheduling to form schedules. (Block 504). In some examples, the schedule requester circuitry 202 may determine whether the WBMS 100 uses implicit or explicit scheduling as part of an initialization and/or connection procedure with the battery controller 102. In other examples, the battery controller 102 may send a message to the battery modules 204 during operation to indicate the scheduling technique has changed between explicit and implicit.

If the schedule requester circuitry 202 determines explicit scheduling is being used to form schedules (Block 504: Yes), the schedule requester circuitry 202 causes the secondary network node 106A to send a transmission request to the primary network node 104 based on the transmission request. (Block 506). As described above, the transmission request is metadata that indicates what data (e.g., error codes, status updates, etc.), if any, should be transmitted from the battery module 204A to the battery controller 102. In some examples, the schedule requester circuitry 202 uses the determination of block 502 to form a transmission request that includes one or more of the parameters described above in connection with FIG. 4. In other examples, the transmission requirement indicates the battery module 204A does not have data to provide to the battery controller 102. In such examples, the schedule requester circuitry 202 does not generate a transmission request based on the determination of block 502. Control proceeds to block 512 after 506.

If the schedule requester circuitry 202 determines implicit scheduling is being used to form schedules (Block 504: No), the schedule requester circuitry 202 determines whether a default schedule would be sufficient to satisfy the transmission requirements. (Block 508). For example, the default sufficient may satisfy the transmission requirements if: (a) the amount of time assigned to the battery module 204A in the default schedule matches the amount of time the battery module 204A requires to transmit data, and (b) the default schedule enables the battery module 204A to transmit the data before any timing deadlines identified in the transmission requirements. In other examples, the battery module 204A considers other factors when determining if the default schedule satisfies the transmission requirements.

If the schedule requester circuitry 202 determines a default schedule would be sufficient to satisfy the transmission requirements (Block 508: Yes), control proceeds to block 512. The schedule requester circuitry 202 does not cause the secondary network node 106A to send a transmission request because, in such an example with implicit scheduling, the default assumption of the battery controller 102 accurately reflects the needs determined in block 502.

If the schedule requester circuitry 202 determines a default schedule would not be sufficient to satisfy the transmission requirements (Block 508: No), the secondary network node 106A sends a transmission request to the primary network node 104A based on the transmission request. (Block 510). The secondary network node 106A may implement block 510 as described above in connection with block 506.

The battery module 204A receives a schedule from the battery controller 102. (Block 512). The schedule assigns slots of a superframe interval to one or more of the battery modules 204A as described above.

The battery module 204A transmits data to the battery controller 102 based on the schedule. (Block 514). The battery module 204A can use a schedule to determine: (a) which of the battery modules 204 will transmit in the upcoming superframe, (b) the order of the transmissions, and (c) the length of the transmissions. Accordingly, the battery module 204A may transmit data during a superframe interval for an assigned time and duration if the corresponding schedule indicates the battery module 204A should do so. In other examples, the schedule does not assign a transmission slot to the battery module 204A, and the battery module 204A does not transmit data during the corresponding superframe interval (e.g., during block 514).

The battery module 204A determines if the WBMS 100 will implement another superframe interval. (Block 516). In some examples, superframe intervals occur continuously while the WBMS 100 is powered on. In other examples, superframe intervals occur at a different rate. The number and frequency of superframe intervals may depend on factors that include but are not limited to the type of battery modules 204, number of battery modules 204, type of battery controller 102, etc.

If the WBMS 100 will implement another superframe interval (Block 516: Yes), control returns to block 502 where the battery module 204A re-determines its transmission requirements. If the WBMS 100 will not implement another superframe interval (Block 516), the machine readable instructions and/or operations 500 end.

FIG. 6 is an illustrative example of sequential scheduling used by the WBMS 100 of FIG. 1. FIG. 6 includes the secondary network nodes 106A-106H and the example schedule 600. The schedule 600 includes example transmission slots 602A-602I.

The transmission slots 602B-602I refer to equal portions of time within a superframe interval. In examples described herein, the amount of time within one transmission slot of a superframe interval is referred to as x milliseconds (ms).

In the example of FIG. 6 described below, the battery controller 102: (a) uses implicit scheduling, and (b) received a total of two transmission requests before the superframe that implements schedule 600 (e.g., at block 402 of FIG. 4). In practice, either scheduling technique and any number of transmission requests may cause the schedule determiner circuitry 216 to generate the schedule 600.

In the example of FIG. 6, the first transmission request identifies the battery module 204A. The schedule determiner circuitry 216 uses the first transmission request to determine the data to be transmitted is an error code that needs 2× milliseconds within a superframe interval.

In the example of FIG. 6, the second transmission request identifies the battery module 204B. The schedule determiner circuitry 216 uses the second transmission request to determine: (a) the data to be transmitted is a status update that needs x ms within a superframe interval, and (b) the data has a self-assigned low priority level.

The schedule determiner circuitry 216 creates the schedule 600 by adjusting the default schedule. In particular, transmission slot 602C would be assigned to the secondary network node 106B in a default schedule but is instead assigned to the secondary network node 106A in schedule 600. As a result, the secondary network node 106A can transmit its requested 2× milliseconds over the course of two consecutive transmission slots 602B and 602C. In other words, the schedule determiner circuitry 216 may be configured to aggregate, for secondary network node 106A, a dual or double sequential slot. In the schedule 600, secondary network node 106A will occupy two adjacent uplink time slots, allowing for a larger data transfer without fragmentation. A double time slot is just one example; the schedule determiner circuitry 216 can instead assign another multiple (e.g., a triple time slot) or a time slot that is not a multiple of a standard time slot (e.g., fifty percent longer than a standard time slot). Although not shown in FIG. 6, the schedule determiner circuitry 216 may be configured to assign larger time slots in a single superframe to multiple secondary network nodes. Within the same superframe interval, secondary network nodes 106C-106H each transmit in one of the transmission slots 602D-602I. Although not shown in FIG. 6, the schedule determiner circuitry 216 may be configured to create a schedule assigning a double sequential slot (e.g., consecutive transmission slots 602B and 602C) to secondary network node 106B, thereby skipping secondary network node 106A.

To make space for the 2× milliseconds transmission of secondary network node 106A, the schedule determiner circuitry 216 prevents the secondary network node 106B from transmitting the status update during schedule 600. The secondary network node 106B is selected to be skipped because the status update has a lower priority than other messages within the corresponding superframe interval. In some examples, the schedule determiner circuitry 216 then updates the priority of the status update to increase the likelihood the secondary network node 106B will transmit in the superframe interval that comes after the schedule 600.

In general, sequential scheduling refers to any superframe schedule where a node (e.g., secondary network node 106A) transmits over two or more consecutive transmission slots (e.g., transmission slots 602B and 602C). In some examples, the schedule determiner circuitry 216 creates a sequential schedule so that the entirety of a message that does not fit within one transmission slot can still be transmitted in a single, continuous portion of the superframe interval.

In the schedule 600 of FIG. 6, the number of transmission slots 602B-602I (eight) for battery modules is equal to the number of connected battery modules 204 (eight) from FIG. 2. In other examples, the number of transmission slots for battery modules in a schedule may be less than or greater than the number of connected battery modules. For example, a secondary network node 106A may need to uplink data every other superframe. In such an example, the schedule for a first superframe may include a time slot for said secondary network node 106A, but the schedule for the next superframe will not include a time slot for that secondary network node 106A. In another example, the battery controller 102 may determine the that battery module 204B has twice as much information to transmit than the other connected battery modules 204. The battery controller 102 may use such information to divide a superframe interval into nine transmission slots so that battery module 204B can transmit for twice as long without skipping other battery modules. In general, the battery controller 102 can use any schedule criteria (e.g., a transmission request, a policy, etc.) as a basis for determining the number of transmission slots within a superframe interval.

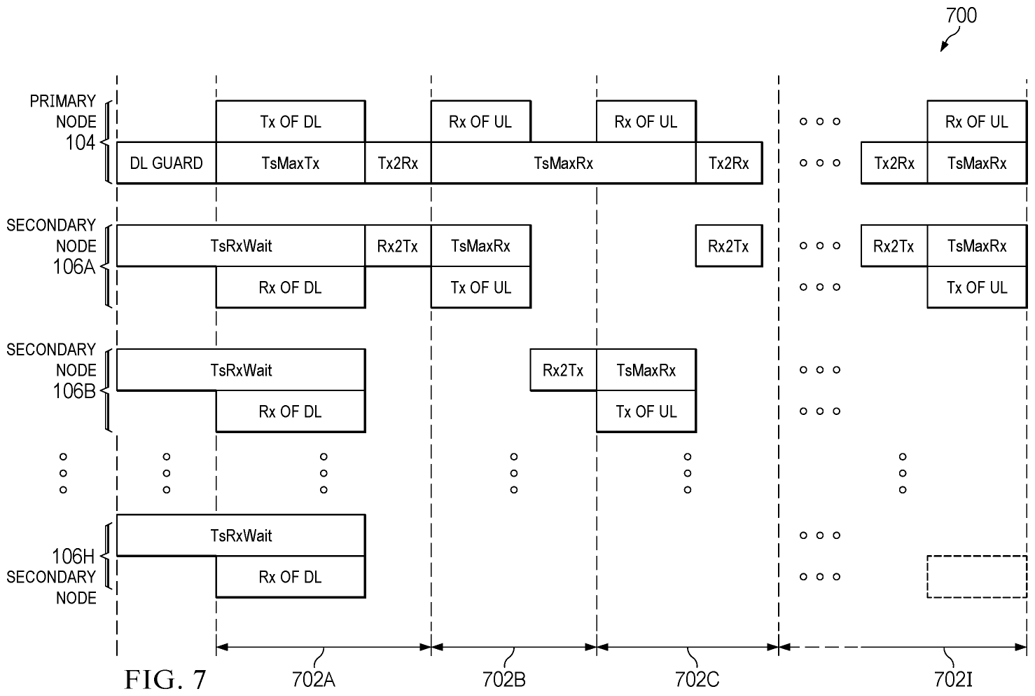

FIG. 7 is an illustrative example of non-sequential scheduling used by the WBMS 100 of FIG. 1. FIG. 7 includes the secondary network nodes 106A-106H and an example schedule 700. The schedule 700 includes example transmission slots 702A-702I. The techniques described with respect to FIG. 7 may be used separately or in combination with the techniques described with respect to FIG. 6. Moreover, although FIG. 7 depicts a schedule allocating two time slots to secondary network node 106A, the schedule determiner circuitry 216 may create a schedule that allocates three or more time slots to a secondary network node, possibly including two or more sequential time slots.

The transmission slots 702B-702I refer to equal portions of time within a superframe interval. In examples described herein, the amount of time within one transmission slot of a superframe interval is referred to as x milliseconds (ms).

In the example of FIG. 7 described below, the battery controller 102: (a) uses implicit scheduling, and (b) received a total of two transmission requests at block 402 of FIG. 4. In practice, either scheduling technique and any number of transmission requests may cause the schedule determiner circuitry 216 to generate the schedule 700.

In the example of FIG. 7, the first transmission request identifies the battery module 204A. The schedule determiner circuitry 216 uses the first transmission request to determine the data to be transmitted is an error code that needs 2× milliseconds within a superframe interval for transmission. The schedule determiner circuitry 216 assigns a high priority level to the data described in the first transmission request.

In the example of FIG. 7, the second transmission request identifies the battery module 204B. The schedule determiner circuitry 216 uses the second transmission request to determine: (a) the data to be transmitted describes performance metrics of the battery cell 108B, and (b) the data needs x ms within a superframe interval for transmission. The schedule determiner circuitry 216 also assigns a high priority level to the data described in the second transmission request.

In the example of FIG. 6, the schedule determiner circuitry 216 could schedule 2× millisecond transmission of secondary network node 106A sequentially because the default assignment of an adjacent transmission slot (e.g., the assignment of secondary node 216B to transmission slot 602C) contained self-assigned low priority data that could be temporarily. In the example of FIG. 7, however, both secondary network nodes 106A and 106B have high priority data that needs transmission within the next superframe interval.

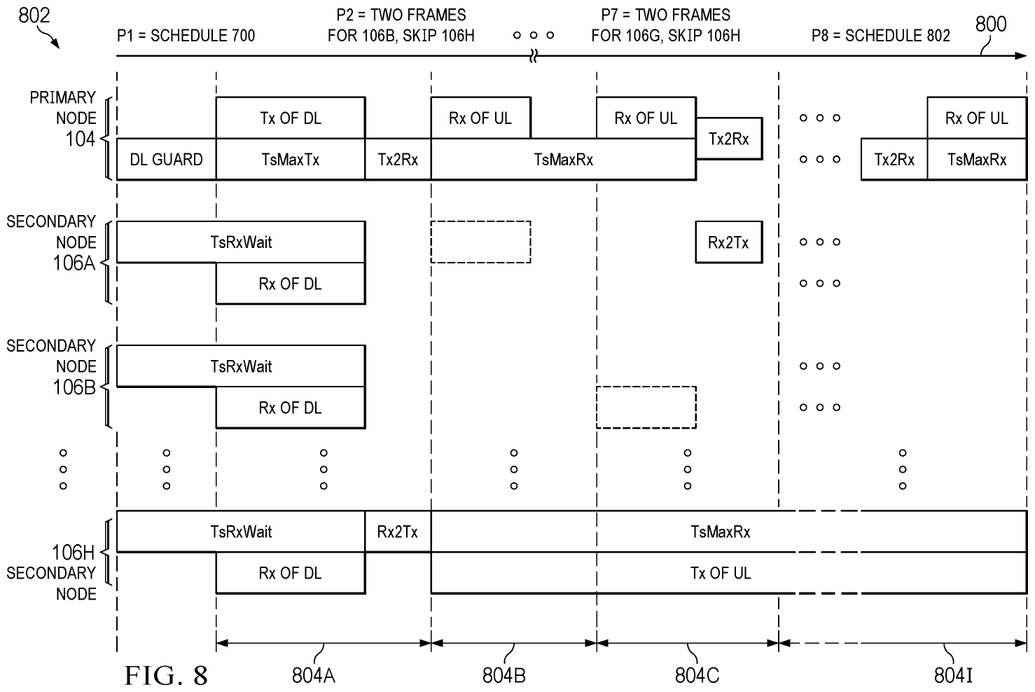

The schedule determiner circuitry 216 accommodates the foregoing transmission needs by adjusting a default schedule and creating the schedule 700. In particular, transmission slot 702I would be assigned to the secondary network node 106H in a default schedule but is instead assigned to the secondary network node 106A in schedule 700. The schedule determiner circuitry 216 may decide to secondary network skip node 106H despite an implicit request for transmission for any reason. Examples where the schedule determiner circuitry 216 does not include a node on a schedule despite that node requesting transmission are discussed further in FIG. 8.

In general, non-sequential scheduling refers to any superframe schedule where anode (e.g., secondary network node 106A) transmits over two or more non-consecutive transmission slots within a single superframe interval (e.g., transmission slots 702B and 702I). While the 2× millisecond-sized error code is divided into two portions in the example of FIG. 7, the break in transmission enables the secondary network node 106B to also transmit its high priority performance metrics in the same superframe interval. Advantageously, by using non-sequential scheduling, the schedule determiner circuitry 216 can accommodate the heterogeneous transmission requests of the example of FIG. 7.

FIG. 8 is an illustrative example of multi-frame scheduling used by the WBMS 100 of FIG. 1. FIG. 8 includes the secondary network nodes 106A-106H, an example timeline 800, and an example schedule 802. The schedule 802 includes example transmission slots 804A-804I. FIG. 8. While the description below provides one specific example that leads to the generation of schedule 802, in practice, either scheduling technique and any number of transmission requests may cause the schedule determiner circuitry 216 to generate the schedule 802.

The transmission slots 802B-802I refer to equal portions of time within a superframe interval. In examples described herein, the amount of time within one transmission slot of a superframe interval is referred to as x milliseconds (ms).

In the example of FIG. 8 described below, the battery modules 204 and the battery controller 102 communicate over a series of superframe intervals as described in the timeline 800. The timeline 800 describes eight periods that correspond to a superframe interval.

Before the first period (P1) of the timeline 800, the battery controller 102 receives a transmission request that identifies the secondary network node 106H. The transmission request indicates that a large amount of data (e.g., an error log) will need a full superframe interval to be transmitted from the secondary network node 106H.

The schedule determiner circuitry 216 creates schedules described in the timeline 800 based on the transmission request. In P1 of the timeline 800, the WBMS 100 implements schedule 700 in which secondary network node 106A transmits in two transmission slots and secondary network node 106H is skipped. In P2, the WBMS 100 implements a schedule in which secondary network node 106B transmits in two transmission slots and secondary network node 106H is skipped. The schedule determiner circuitry 216 continues this pattern of schedules through P7, where secondary network node 106G transmits in two transmission slots and secondary network node 106H is skipped.

At P8, the WBMS 100 implements the schedule 802. The schedule determiner circuitry 216 created the schedule 802 to assign all eight transmission slots available for battery module transmission (e.g., transmission slots 804B-804I) to the secondary network node 106H, thereby skipping the other secondary network nodes 106A-106G. Accordingly, the battery module 204H informs the battery controller 102 about the error log before P1 and sends the error log as a single, continuous transmission during P8.

By providing eight transmission slots each to battery modules 204A-204G across P1 through P7, and by skipping battery module 204H across P1 through P7, the schedule determiner circuitry 216 can assign P8 exclusively to battery module 204H. As a result, each of the battery modules 204 transmit the same amount of data across P1 through P8, even though one of the messages (e.g., the error log of P8) contains more data than other messages.

In general, multi-frame scheduling refers to use cases where the schedule determiner circuitry 216 uses two or more schedules to address a given transmission request. In the example of FIG. 8, eight total schedules are used to address the transmission request of secondary network node 106H, which was sent before P1.

In other examples, the schedule determiner circuitry 216 uses a different number of schedules to address a transmission request. The number of schedules that may occur before a given transmission request is addressed may depend on any number of factors, including but not limited to the contents of the transmission requests, the number of connected battery modules, other transmission requests received before or after the transmission request in question, etc. Advantageously, the schedule determiner circuitry 216 uses multi-frame scheduling to provide flexibility when addressing heterogeneous transmission requests.

The schedule determiner circuitry 216 may receive a request for long-term allocation that spans multiple superframes. For example, a battery module can request, for example, a double slot allocation across several superframes. A long-term request may include an indication of the number of requested time slots and the number of requested superframes. The schedule determiner circuitry 216 may be configured to create a schedule and communicate to the secondary network nodes 106A-106H when the long-term allocation will begin and/or end. After sending a long-term request, the secondary network node may receive the requested allocations without having to send any additional requests during the term of the request. In contrast to long-term requests, some requests may be short-term and apply to only one superframe.

FIG. 9 is a block diagram of an example programmable circuitry platform 900 structured to execute and/or instantiate the example machine-readable instructions and/or the example operations of FIGS. 4 and 5 to implement the WBMS 100 of FIG. 2. The programmable circuitry platform 900 can be, for example, an EV, an HEV, a server, a personal computer, a workstation, an Internet appliance, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the battery controller 102 and the battery modules 204 of FIG. 2.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, a steering wheel, a gas pedal, a brake pedal, a control console, an infotainment system, a camera (still or video), a light detection and ranging (LIDAR) sensor, a keyboard, a button, a mouse, a touchscreen, and/or any other automotive input.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a motor, a transmission, a wheel axle, and/or any other automotive output. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 4 and 5, may be stored in the mass storage device 928, in the volatile memory 914, in the non-volatile memory 916, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first”, “second”, “third”, etc. are used merely to distinguish between elements of substantially the same type in terms of structure and/or function. These identifiers used in the detailed description do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that support superframe communication with heterogeneous battery modules. Described systems, apparatus, articles of manufacture, and methods improve the efficiency of using a computing device by implementing schedule requester circuitry 202 within battery modules 204 to provide transmission requests describing various types, amounts, and priority of data to be transmitted. The WBMS 100 also implements schedule determiner circuitry 216 within the battery controller 102 to create different schedules for superframe intervals based on the transmission requests. The schedule determiner circuitry 216 may use sequential scheduling, non-sequential scheduling, or multi-frame scheduling techniques based on the transmission requests. The different schedules allow the battery modules 204 to provide heterogeneous messages within a superframe T1 communication standard. Described systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry; and
programmable circuitry configured to:
transmit a first schedule to a set of battery modules, the first schedule to assign transmission slots to one or more of the set of battery modules for a first communication period;
create a second schedule different from the first schedule; and
transmit the second schedule to the set of battery modules, the second schedule to assign transmission slots to one or more of the set of battery modules for a second communication period.

2. The apparatus of claim 1, wherein the second schedule is based on a transmission request sent by a first battery module within the set.

3. The apparatus of claim 1, wherein the second schedule is based on a policy implemented by the programmable circuitry.

4. The apparatus of claim 1, wherein:
the programmable circuitry is configured to create the second schedule based on explicit transmission requests; and
the second schedule only assigns transmission slots to battery modules within the set that sent an explicit transmission request to the programmable circuitry.

5. The apparatus of claim 1, wherein:
the programmable circuitry is configured to create the second schedule based on implicit transmission requests; and
the second schedule assigns a first transmission slot to a battery module that did send a transmission request to the programmable circuitry and a second transmission slot to a battery module that did not send a transmission request to the programmable circuitry.

6. The apparatus of claim 1, wherein:
the second schedule includes an ordered listing of the set of battery modules, the number of transmission slots equal to the number of battery modules in the set;
a first battery module within the set requests two transmission slots after the first communication period;
a second battery module within the set and the first battery module correspond to consecutive indices on the ordered listing; and
the programmable circuitry is configured to create the second schedule such that there are two consecutive transmission slots assigned to the first battery module and no transmission slots assigned to the second battery module.

7. The apparatus of claim 1, wherein:
the second schedule includes an ordered listing of the set of battery modules, the number of transmission slots equal to the number of battery modules in the set;
a first battery module within the set requests, after the first communication period, more than one transmission slots;
a second battery module within the set and the first battery module correspond to consecutive indices on the ordered listing; and
the programmable circuitry is configured to create the second schedule such that the more than one transmission slots are assigned to the first battery module and no transmission slots are assigned to the second battery module.

8. The apparatus of claim 1, wherein:
the second schedule includes an ordered listing of the set of battery modules;
the programmable circuitry is configured to:
obtain, after the first communication period, a first transmission request that indicates a first battery module in the set requests two transmission slots; and
obtain, after the first communication period, a second transmission request from a second battery module within the set, the first battery module and the second battery module having consecutive indices on the ordered listing;
determine a third battery module in the ordered listing has a lower priority than the second battery module; and
create the second schedule such that there are two transmission slots assigned to the first battery module, one transmission slot assigned to the second battery module, and no transmission slots assigned to the third battery module.

9. The apparatus of claim 8, wherein the programmable circuitry is configured to:
increase a priority of the third battery module after determining that the third battery module has a lower priority than the second battery module; and
create a third schedule based on the increased priority of the third battery module, wherein the third schedule is different from the second schedule, and wherein the third schedule corresponds to a third communication period.

10. The apparatus of claim 1, wherein the programmable circuitry is configured to:
receive, during a transmission slot within the second communication period, an uplink message from a battery module in the set; and
perform an action based on the uplink message.

11. An apparatus comprising:
interface circuitry; and
programmable circuitry configured to:
determine a first transmission requirement;
send the first transmission requirement to a controller;
receive a schedule from the controller, the schedule to assign transmission slots within a first communication period to a set of devices, the set including the apparatus;
transmit, based on the schedule, data corresponding to the first transmission requirement; and
determine, after the first communication period, a second transmission requirement corresponding to a second communication period, the second transmission requirement different than the first transmission requirement.

12. The apparatus of claim 11, wherein:
the controller uses implicit scheduling; and
the programmable circuitry is configured to send the first transmission requirement to the controller after a determination that a default schedule would not satisfy the first transmission requirement.

13. The apparatus of claim 11, wherein:
the controller uses implicit scheduling; and
the programmable circuitry is configured to:
after the first communication period, determine whether a default schedule would satisfy the second transmission requirement; and
after a determination the default schedule would satisfy the second transmission requirement, wait to receive the schedule without sending the second transmission requirement.

14. The apparatus of claim 11, wherein:
the first transmission requirement corresponds to a request for two transmission slots; and
the programmable circuitry is configured to transmit, based on the schedule, in two consecutive transmission slots during the first communication period.

15. The apparatus of claim 11, wherein:
the first transmission requirement corresponds to a request for more than one transmission slots; and
the programmable circuitry is configured to transmit, based on the schedule, more than one non-consecutive transmission slots during the first communication period.

16. The apparatus of claim 11, wherein the data transmitted by the apparatus during the first communication period includes a status update, an error code, a renegotiation, or a performance metric.

17. A method comprising:
transmitting a first schedule to a set of battery modules, the first schedule to assign transmission slots to one or more of the set of battery modules for a first communication period;
creating a second schedule different from the first schedule; and
transmitting the second schedule to the set of battery modules, the second schedule to assign transmission slots to one or more of the set of battery modules for a second communication period.

18. The method of claim 17, further including creating the second schedule based on explicit transmission requests, the second schedule only to assign transmission slots to battery modules within the set that sent an explicit transmission request corresponding to the second schedule.

19. The method of claim 17, further including creating the second schedule based on implicit transmission requests, the second schedule to:
assign a first transmission slot to a battery module in the set that did send a transmission request corresponding to the second schedule; and
assign a second transmission slot to a battery module that did not send a transmission request corresponding to the second schedule.

20. The method of claim 17, wherein:
the second schedule includes an ordered listing of the set of battery modules;
a first battery module in the set requests two transmission slots after the first communication period;
a second battery module in the set and the first battery module correspond to consecutive indices on the ordered listing; and
the method further includes creating the second schedule such that there are two consecutive transmission slots assigned to the first battery module and no transmission slots assigned to the second battery module.
